(19) United States
(12) Patent Application Publication
(10) Pub. No.: US 2023/0088598 A1
(43) Pub. Date: Mar. 23, 2023

(54) LABEL REMOVER APPARATUS AND USE THEREOF

(71) Applicant: Law Office of Jerry Joseph, PLC, Washington, DC (US)

(72) Inventor: Kemblie Gay, Manassas Park, VA (US)

(21) Appl. No.: 17/949,100

(22) Filed: Sep. 20, 2022

Related U.S. Application Data
(60) Provisional application No. 63/246,867, filed on Sep. 22, 2021.

(51) Int. Cl. B08B 9/08; B08B 13/00

(52) U.S. Cl. CPC B08B 9/083; B08B 9/0808; B08B 9/0821; B08B 13/00; B08B 2209/08; B08B 2220/01

(57) ABSTRACT

An apparatus for removing material from an object including a support structure accommodating the object and a material remover supported by the support structure and biased against the material, wherein movement of the object relative to the material remover removes the material.

### FIELD OF THE INVENTION

The present general inventive concept relates generally to an apparatus and use thereof for removal of labels from objects. More particularly, exemplary embodiments relate to an apparatus and use thereof for removal of labels applied to containers, for example, medicine containers such as prescription pill bottles.

### CROSS-REFERENCE TO RELATED APPLICATION

The present invention claims priority from the following U.S. Provisional Application, the entire disclosure of which, including but not limited to any and all cited references, is incorporated herein by reference: U.S. Provisional Application No. 63/246,867 filed on Sep. 22, 2022.

### BACKGROUND OF THE INVENTION

There have been previous methods for removing labels from containers. For example, previously an individual would try to scrape a label off an outer face of a container with a sharp object, which presented a risk of injury to the individual. In other instances, an individual would try to scrape a label off a container with a fingernail, which presented a risk of breaking the fingernail. In still other instances, an individual would try to saturate a label with rubbing alcohol or nail polish remover, which presented a risk of damaging the individual's skin.

Therefore, what is needed is an apparatus and method that provide for quick, efficient, and safe removal of a label from a container.

### SUMMARY OF THE INVENTION

Certain of the foregoing and related aspects are readily attained according to the present general inventive concept by providing an apparatus and use thereof for removal of labels from objects.

More particularly, the present invention provides an apparatus for removing material, such as a private medical information label, from an object, such as a prescription pill bottle, the apparatus including a support structure accommodating the bottle and a material remover supported by the support structure and biased against the label.

In preferred embodiments, the material remover includes a remover surface with a rough texture. Therefore, movement of the bottle relative to the material remover removes the label.

In preferred embodiments, to facilitate such relative movement, the support structure includes a recess that accommodates the bottle and permits movement of the bottle, within the recess, relative to the material remover.

Preferably, at least a portion of the bottle remains outside the recess when the bottle is accommodated by the recess. In certain embodiments, this is because the support structure includes a feature, such as a protrusion, that prevents the portion from entering the recess. In some of those and other embodiments, the bottle includes a feature, such as a lid, that prevents the portion from entering the recess.

In preferred embodiments, the recess also permits movement of the material remover relative to the bottle when the bottle is accommodated by the recess.

In preferred embodiments, rotation of the bottle about a longitudinal axis of the bottle removes the label. In certain embodiments, the bottle is cylindrical, and the support structure includes a cylindrical recess that permits rotation of the bottle, within the recess, about the longitudinal axis of the bottle. Further in preferred embodiments, rotation of the material remover about a longitudinal axis of the material remover removes the label.

In preferred embodiments, the support structure is configured to bias the bottle toward the material remover. In certain embodiments, the support structure includes one or more biasing agents that force the bottle toward the material remover.

In preferred embodiments, the support structure accommodates a housing for engagement with the support structure, the housing including the material remover, and engagement of the housing with the support structure biases the remover surface against the label.

In preferred embodiments, the material remover includes a remover tool having the remover surface biased against the label, and a remover tool driver for driving the remover tool to rotate about a longitudinal axis of the remover tool to move the remover surface relative to the label.

In preferred embodiments, the bias extends to a distance approximately equal to a thickness of the label.

In preferred embodiments, the recess of the support structure has a debris collection volume below the bottle when the bottle is accommodated by the recess.

In preferred embodiments, the apparatus further includes at least one sensor that detects when the material remover is biased against the label, the sensor triggering movement of the material remover relative to the bottle.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a front perspective view illustrating use of a label remover apparatus according to an embodiment of the present general inventive concept;

FIG. 2 is a front view illustrating the use of the label remover apparatus illustrated in FIG. 1;

FIG. 3 is a front perspective view illustrating the use of the label remover apparatus illustrated in FIG. 1;

FIG. 4 is a front view illustrating the use of the label remover apparatus illustrated in FIG. 1;

FIG. 5 is a cross-sectional view along line A-A illustrated in FIG. 4;

FIG. 6 is a front perspective view of the label remover apparatus illustrated in FIG. 1;

FIG. 7 is a front view of the label remover apparatus illustrated in FIG. 6;

FIG. 8 is a side view of the label remover apparatus illustrated in FIG. 6;

FIG. 9 is a top view of the label remover apparatus illustrated in FIG. 6;

FIG. 10 is a bottom view of the label remover apparatus illustrated in FIG. 6;

FIG. 11 is a front perspective view of the label remover apparatus illustrated in FIG. 6, in an unassembled state;

FIG. 12 is a top view of the label remover apparatus illustrated in FIG. 11;

FIG. 13 is a side view of the label remover apparatus illustrated in FIG. 11;

FIG. 14 is a front perspective view of the label remover apparatus illustrated in FIG. 6, in a partially assembled state;

FIG. 15 is a top view of the label remover apparatus illustrated in FIG. 14;

FIG. 16 is a side view of the label remover apparatus illustrated in FIG. 14;

FIG. 17 is a front perspective view of the material remover illustrated in FIG. 6; and

FIG. 18 is a front view of the material remover illustrated in FIG. 17.

### DESCRIPTION OF PREFERRED EMBODIMENTS

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

The following description is provided to assist the reader in gaining a comprehensive understanding of the apparatus and methods described herein. Accordingly, various changes, modifications, and equivalents of the apparatus and methods described herein will be suggested to those of ordinary skill in the art. The progression of method operations described are merely examples, however, and the sequence of operations is not limited to that set forth herein and may be changed as is known in the art, with the exception of operations necessarily occurring in a certain order. Also, descriptions of well-known functions and manufacturing methods may be simplified and/or omitted for increased clarity and conciseness.

Numerous variations, modifications, and additional embodiments are possible, and accordingly, all such variations, modifications, and embodiments are to be regarded as being within the spirit and scope of the present invention. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity may be repeated, any activity may be performed by multiple entities, and/or any element may be duplicated.

Further, it should be understood that the use of “such as”, “for example”, and other like terms and phrases are to be construed as introducing a non-limiting list of examples, and that such list is non-exhaustive. Instead, the present invention is contemplated to cover any and all present and future possible examples that fall within the broadest possible interpretation of the element for which the examples are presented.

Certain of the foregoing and related aspects are readily attained according to the present general inventive concept by providing an apparatus and method for removal of labels.

Reference will now be made in detail to the exemplary embodiments, examples of which are illustrated in the accompanying drawings, wherein like reference numerals refer to the like elements throughout. The exemplary embodiments are described below to explain the features and relationships thereof through reference to the figures.

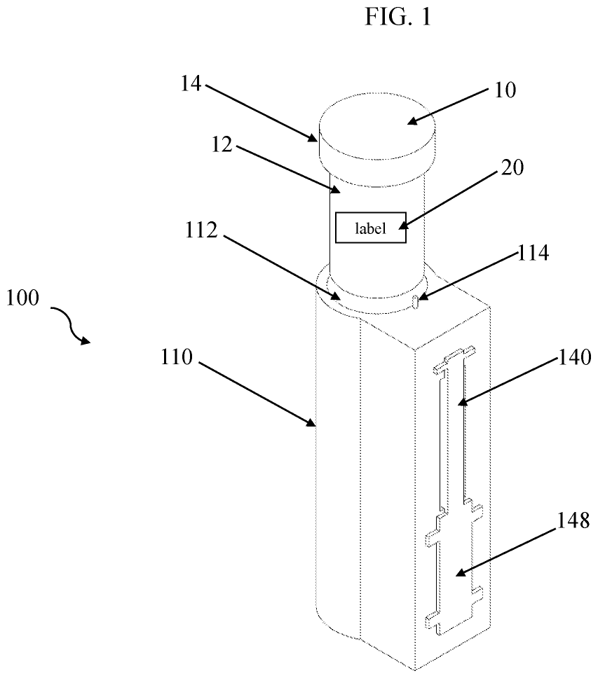

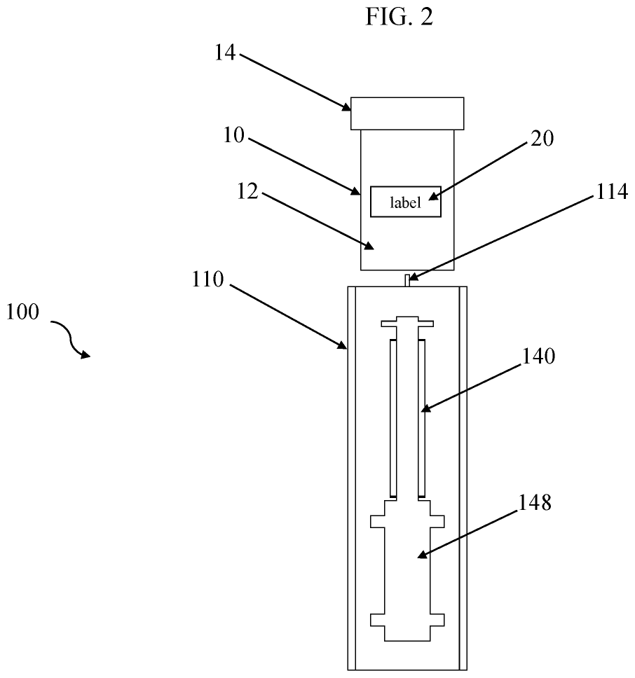

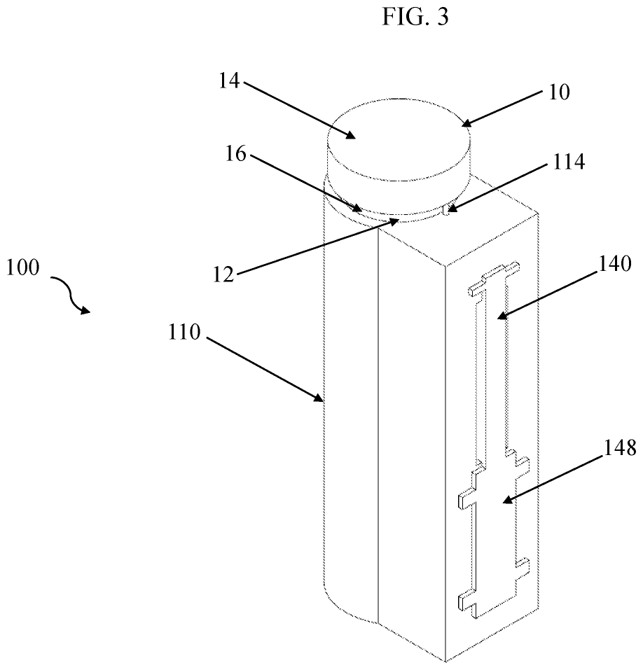

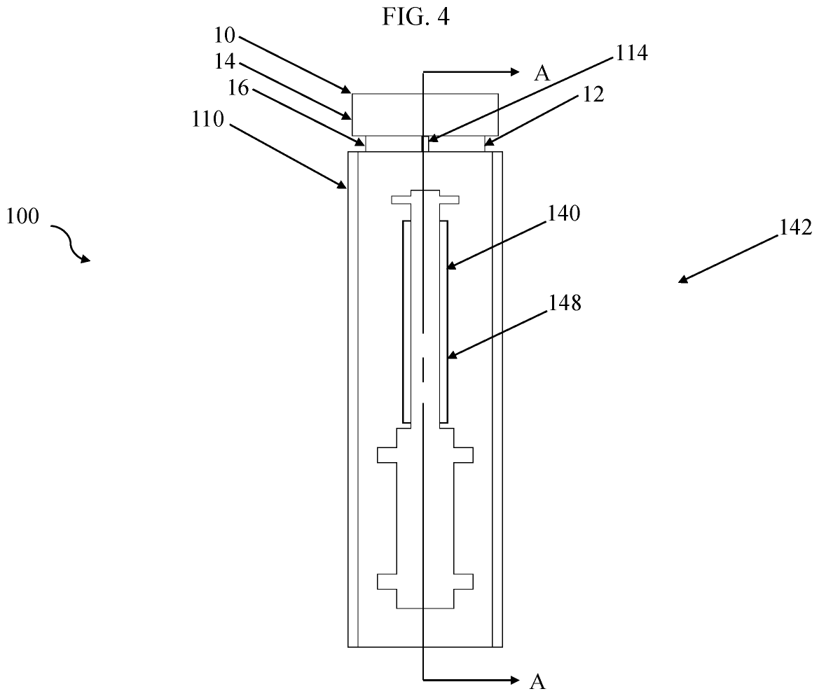

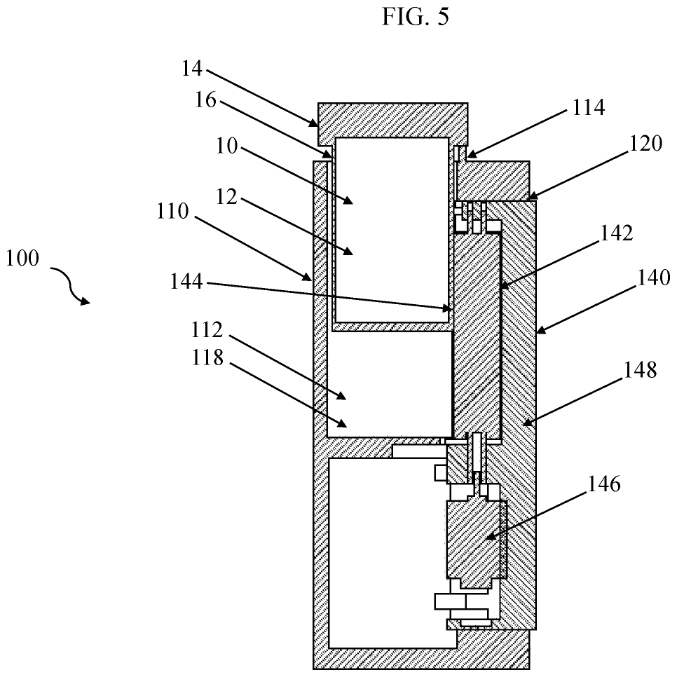

Referring now to FIGS. 1-5.

The illustrated embodiment includes an apparatus 100 for removing material 20 from an object 10. The apparatus 100 includes a support structure 110 accommodating the object 10 and a material remover 140 supported by the support structure 110 and biased against the material 20. Movement of the object 10 relative to the material remover 140 removes the material 20.

More particularly, in the illustrated embodiment, the object 10 is a prescription pill bottle, which has a cylindrical body 12 and a cylindrical lid 14. The body 12 has a diameter. The lid 14 has a diameter larger the diameter of the body 12.

It should be understood that other objects, of any shape, with or without lids, are contemplated for use with the present invention, and that dimensions of elements of the illustrated embodiment can be modified to accommodate the same without departing from the scope of the invention.

Further particularly, in the illustrated embodiment, the material 20 is a label that is adhered to the body 12 of the bottle. The label has private medical information printed or written on it, and therefore it is desirable to remove the label when, for example, the label is no longer needed, the bottle is sent for recycling, or it is otherwise desirable to remove the information.

It should be understood that the present invention encompasses removal of any material from an object, and that an adhered label is only one type of material and is included in the present description as an example only. Other materials, whether part of, integrated with, added to, adhered to, or otherwise associated with the object, are contemplated as being removable by the present invention, and that aspects of elements of the illustrated embodiment can be modified to accommodate the same without departing from the scope of the invention.

In the illustrated embodiment, the support structure 110 includes a recess 112 that accommodates the object 10 and permits movement of the object 10, within the recess 112, relative to the material remover 140.

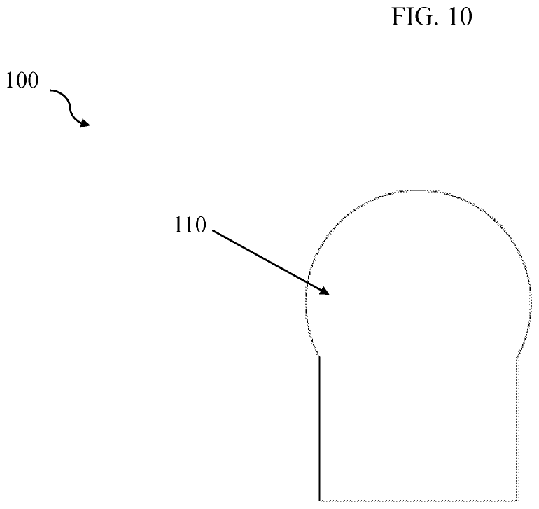

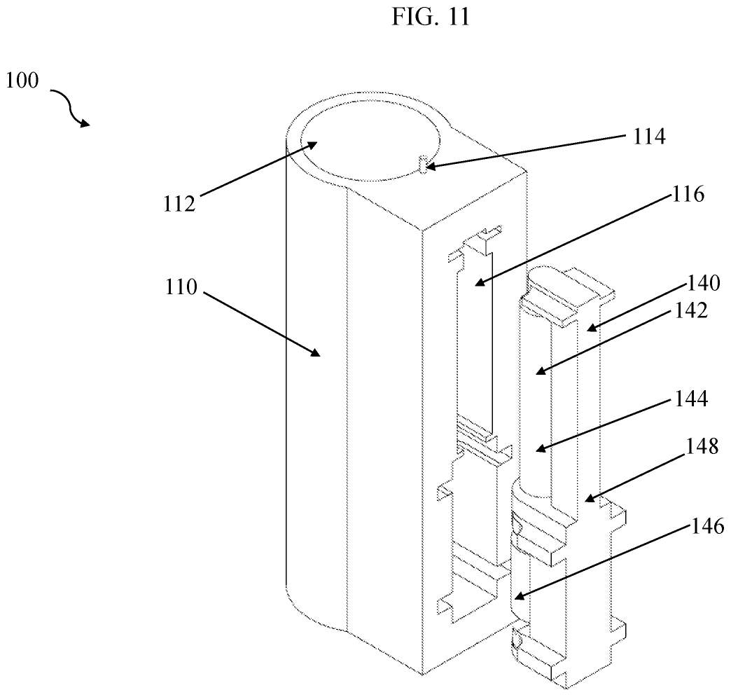

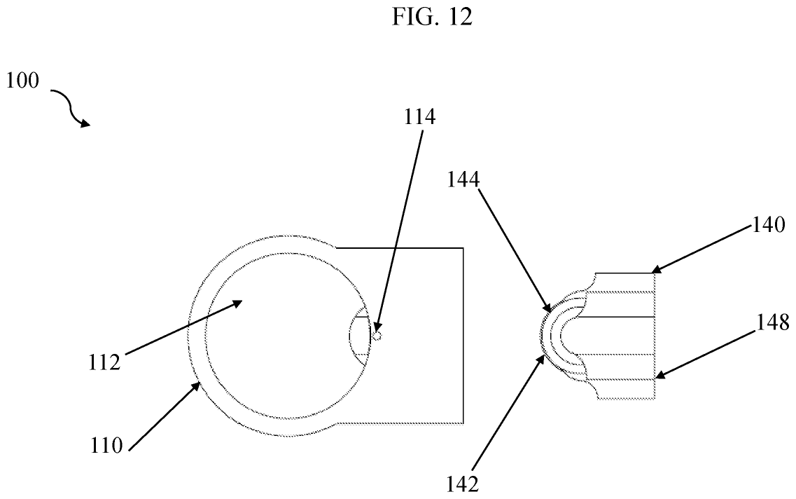

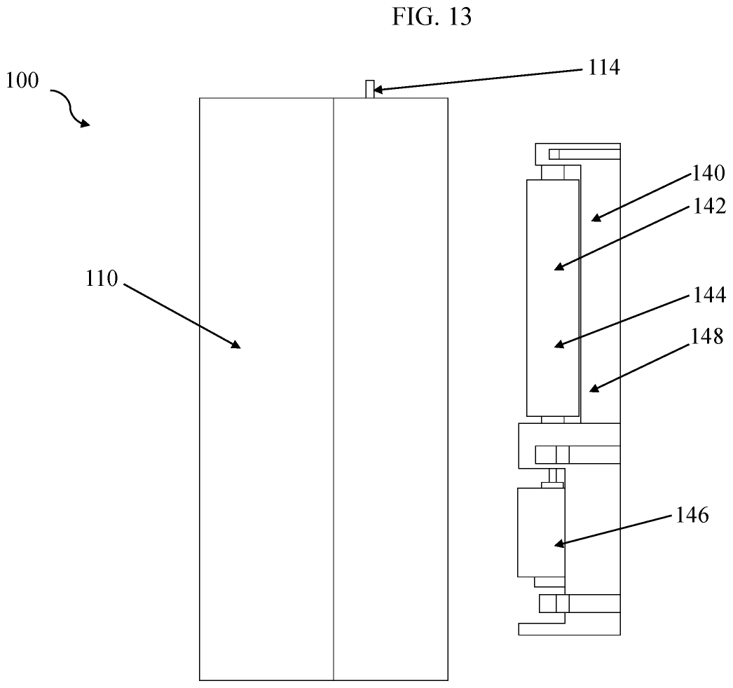

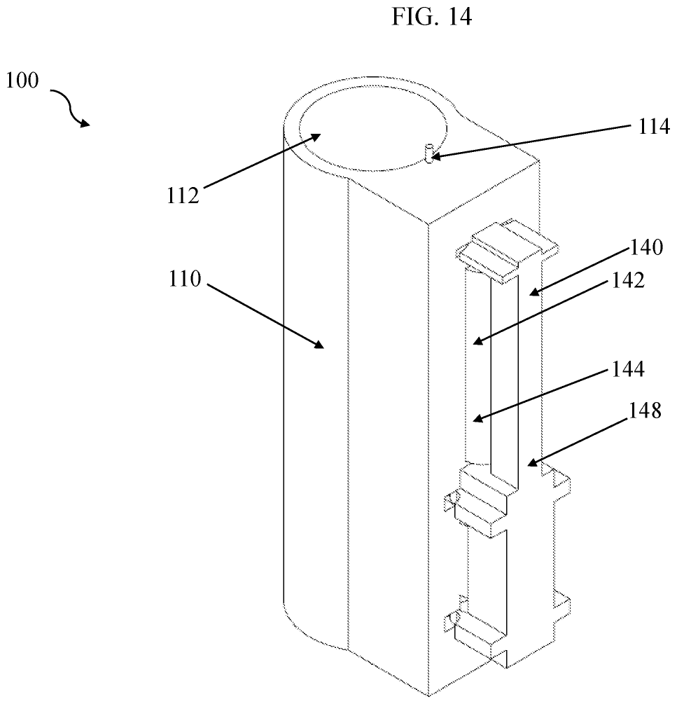

More particularly, in the illustrated embodiment, the support structure 110 is partially cylindrical, and the recess 112 is cylindrical, having a longitudinal axis and having a diameter larger than the diameter of the body 12 of the bottle 10. In FIGS. 10 and 11, the bottle 10 is illustrated as being fully outside the recess 112. In FIGS. 12-14, the bottle 10 is illustrated as being partially inside the recess 112.

It should be understood that while in the illustrated embodiment, the support structure 110 is partially cylindrical and the recess 112 is cylindrical, the support structure 110 and recess 112 can be of any shape, including but not limited to polygonal or rectangular, and be differently shaped than one another, without departing from the scope of the invention. In preferred embodiments, the recess 112 has a sufficient diameter to receive containers of various sizes and shapes. In certain embodiments, the support structure 110 includes features or elements configured to efficiently adjust to accommodate smaller sized containers as necessary. This may be achieved, for example without limitation, by gripping mechanisms or by movement or biasing of at least a portion of a wall of the recess 112 in a radially inward direction.

That is, in the illustrated embodiment, at least a portion 16 of the object 10 remains outside the recess 112 when the object 10 is accommodated by the recess 112.

This is because, in the illustrated embodiment, the support structure includes a feature 114 that prevents the portion 16 from entering the recess 112.

Further, in the illustrated embodiment, the object 10 includes a feature that prevents the portion 16 from entering the recess 112.

More particularly, in the illustrated embodiment, the lid 14 of the bottle 10 is such a feature, because as noted above, the lid 14 has a diameter larger the diameter of the body 12, and the recess 112 has a diameter larger than the diameter of the body 12 but smaller than the diameter of the lid 14. Therefore, although, as illustrated, the feature 114 of the support structure 110 is positioned and dimensioned to prevent the portion 16 from entering the recess 112, the bottle 10 would be prevented from fully entering the recess 112 even if the feature 114 was not present. Preventing the bottle 10 from fully entering the recess 112 eases the removal of the bottle 10 from the recess 112 once the label 20 is removed.

It should be understood that any dimensions of, features of, or elements added to or taken away from one or both of the object and the support structure can configure the apparatus to prevent the object from fully entering the recess, without departing from the scope of the invention. Further, it should be understood that the present invention also contemplates apparatus in which the object can fully enter the recess, and that although in the illustrated embodiment the object is prevented from fully entering the recess to ease its removal from the recess, the present invention also contemplates apparatus in which the object can removed even if it fully enters the recess.

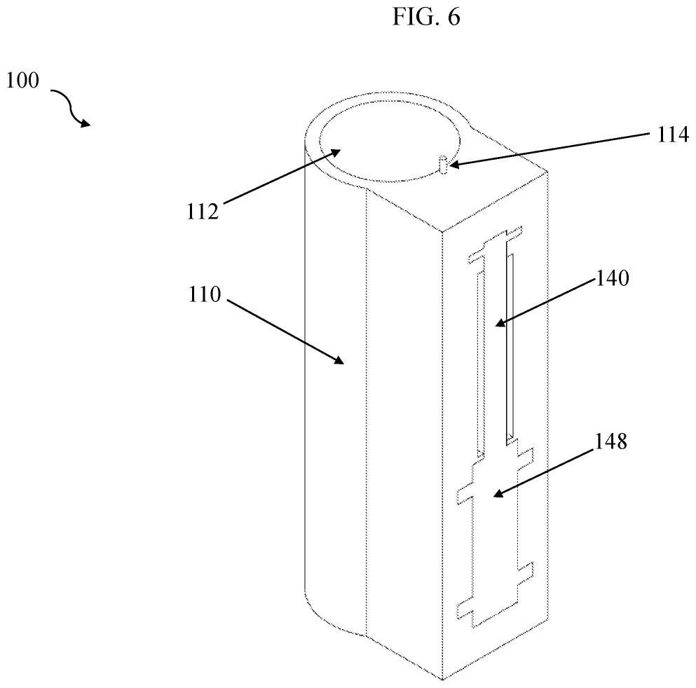

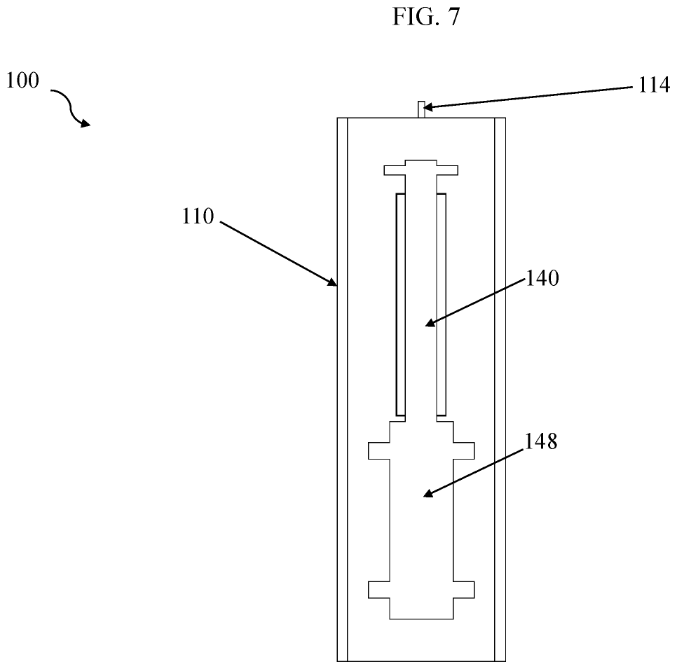

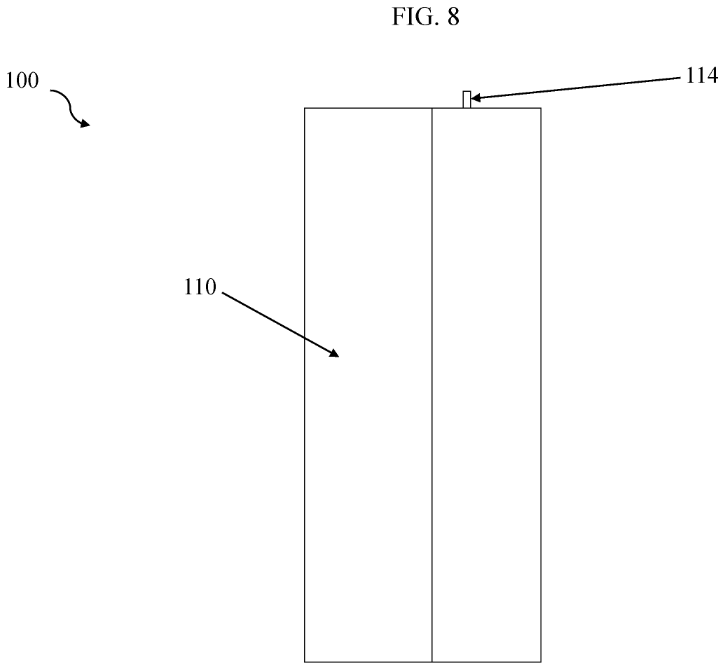

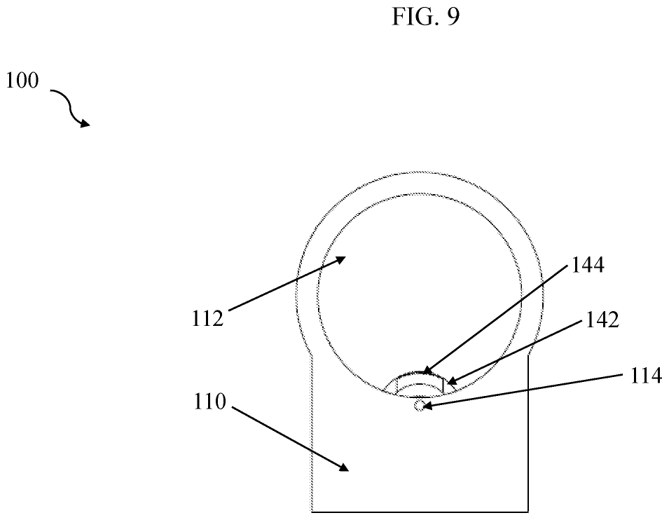

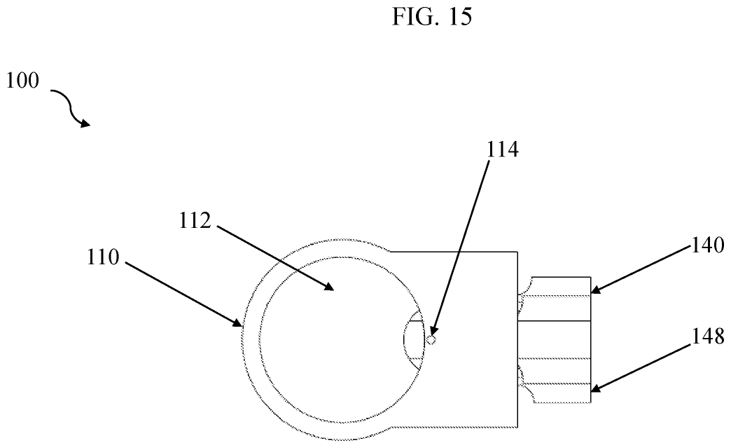

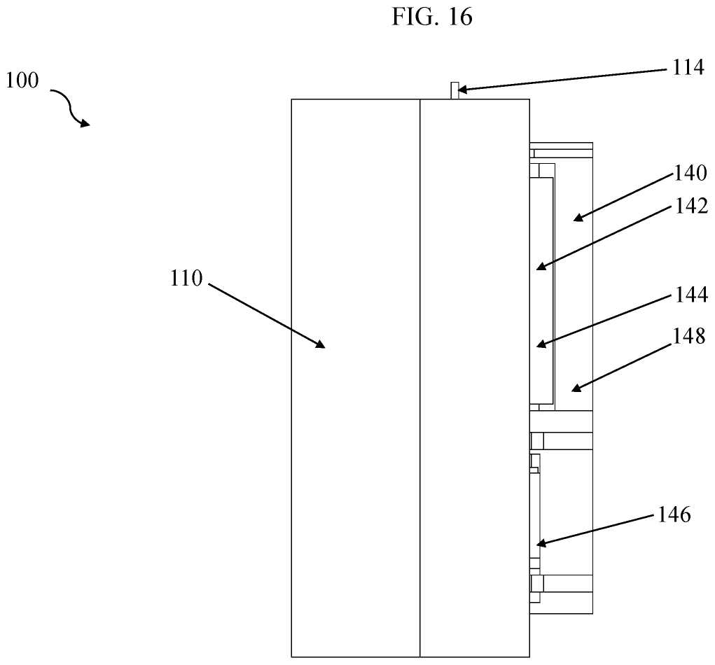

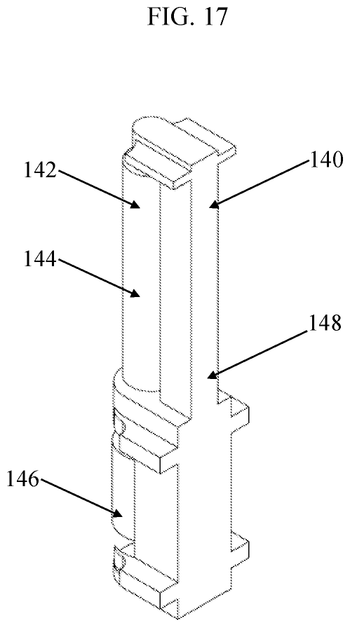

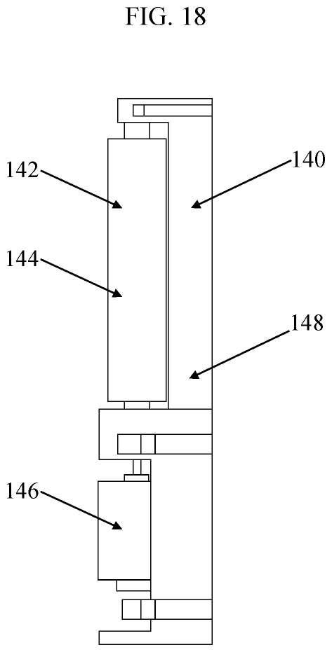

Referring now also to FIGS. 1-16, and further particularly to FIGS. 17-18.

In the illustrated embodiment, the material remover 140 includes a remover tool 142 having a remover surface 144 biased against the material 20, and a remover tool driver 146 for driving the remover tool 142 to rotate about a longitudinal axis of the remover tool 142 to move the remover surface 144 relative to the material 20.

Further in the illustrated embodiment, the remover surface 144 has a rough texture.

Further in the illustrated embodiment, the support structure 110 accommodates a housing 148 for engagement with the support structure, the housing 148 including the material remover 140, and wherein engagement of the housing 148 with the support structure 110 biases the remover surface 144 against the material 20.

More particularly, in the illustrated embodiment, the support structure 110 includes an alcove 116 that accommodates the housing 148 that houses the material remover 140. That is, in the illustrated embodiment, the alcove 116 has an opening with a cross-section dimensioned to closely match the profile of the housing 148, such that the housing 148 can be moved into the alcove 116 for engagement with the support structure 110, and out from the alcove 116 for disengagement from the support structure 110. Preferably, the housing 148 is movable coupled to the support structure 110.

Further particularly, in the illustrated embodiment, engagement of the housing 148 with the support structure 110 biases the remover surface 144 against the label 20 when the bottle 10 is accommodated by the recess 112. After the bottle 10 is positioned in the recess 112, the housing 148 can be moved into the alcove 116 and locked in the alcove 116 to hold the remover surface 144 against the label 20. As to the portion of the label 20 that contains the information targeted for removal, the remover surface 144 preferably is held against the label 20 along a length of the remover surface 144 corresponding to such portion, and most preferably is held against the label 20 along a length of the remover surface 144 corresponding to a full height of the label 20.

In the illustrated embodiment, the support structure 110 is configured to bias the object 10 toward the material remover 140.

More particularly, in the illustrated embodiment, the dimensions of the recess 112 force the object 10 toward the remover tool 142. That is, in the illustrated embodiment, the bottle 10 is cylindrical and the recess 112 is cylindrical, and the diameter of the recess 112 is only slightly larger than the diameter of the body 12 of the bottle 10, so that the body 12 is permitted only limited movement away from the remover tool 142 when the housing 148 is locked in the alcove 116, and such limited movement nevertheless maintains the label 20 against the remover surface 144 under force. Stated alternatively, the label 20 and the remover surface 144 are compressed against one another due to the diameter of the recess 112 preventing separational movement of the body 12 of the bottle 10 away from the remover tool 142, and the locking of the housing 148 in the alcove 116 preventing separational movement of the remover tool 142 away from the body 12 of the bottle 10.

It should be understood that although in the illustrated embodiment, dimensions of the support structure configure the support structure to bias the object toward the material remover, the invention encompasses apparatus in which the support structure includes one or more biasing agents that force the object toward the material remover. For example, without limitation, the support structure in other embodiments can include angled structures, springs, or mechanically driven elements that force the object toward the material remover.

Further, it should be understood that the biasing can be additionally or alternatively be accomplished by dimensions of, features of, or elements added to or taken from one or more of the material remover (or any of its elements), the support structure, or any other aspects of the apparatus.

Further particularly, in the illustrated embodiment, the remover tool 142 of the material remover 140 is a cylinder with a longitudinal axis and is configured to rotate about the longitudinal axis. In the illustrated embodiment, the longitudinal axis of the remover tool 142 is substantially parallel (for example without limitation, inclusively between −15 degrees from true parallel to +15 degrees from true parallel) to the longitudinal axis of the recess 112. The remover surface 144 of the remover tool 142 is the radially outwardly facing surface of the cylinder, and as noted above, has a rough texture. The remover tool driver 146 includes a motor that is controlled by a circuit, powered by a battery or other power source, and mechanically connected to the remover tool 142 by one or more gears such that operation of the motor rotates the remover tool 142.

It should be understood that rotation of the remover tool can be accomplished by other mechanisms, such as for example without limitation, manual operation or powered operation under other power sources, without departing from the scope of the invention. It should further be understood that the remover tool driver can be located elsewhere in the housing, or can be outside the housing, without departing from the scope of the invention.

As described initially above, movement of the object 10 relative to the material remover 140 removes the material 20.

In the illustrated embodiment, rotation of the object about a longitudinal axis of the object removes the material.

Further, in the illustrated embodiment, the object is cylindrical and the support structure includes a cylindrical recess that permits rotation of the object, within the recess, about the longitudinal axis of the object.

More particularly, in the illustrated embodiment, as discussed above, the bottle 10 has a cylindrical body 12 with a diameter. The cylindrical body 12 has a longitudinal axis. Further particularly, in the illustrated embodiment, as discussed above, the recess 112 is cylindrical and has a diameter larger than the diameter of the body 12. Accordingly, the recess 112 permits rotation of the bottle 10 within the recess 112, about the longitudinal axis of the body 12.

Accordingly, in the illustrated embodiment, inasmuch as the label 20 is biased against the remover surface 114, rotation of the bottle 10 within the recess 112, about the longitudinal axis of the body 12, causes the rough texture of the remover surface 114 to remove the label 20 from the body 12, by a removal force, such as for example without limitation, one or more of a tearing force, a shearing force, a cutting force, a pushing force, a scraping force, a scratching force, a rubbing force, or other force.

It should be understood that rotation of the bottle 10 within the recess 112, about the longitudinal axis of the body 12 can be accomplished manually, for example without limitation, gripping the lid 14 of the bottle 10 and rotating the lid 14, which will in turn causes a rotation of the body 12 due to a connection between the lid 14 and the body 12. It should further be understood that manual rotation of the bottle 10 within the recess 112, about the longitudinal axis of the body 12 can be accomplished manually in other ways without departing from the scope of the invention.

It should be understood that rotation of the bottle 10 within the recess 112, about the longitudinal axis of the body 12 can be accomplished other than manually, such as for example without limitation, using an motor rotationally connected to the bottle 10 or using another powered mechanism interacting with the bottle 10, without departing from the scope of the invention.

As described above, movement of the object 10 relative to the material remover 140 removes the material 20. Such movement of the object 10 can be accomplished, for example without limitation, by movement of the object 10, movement of the material remover 140, or movement of both.

It should be understood that in the illustrated embodiment, while not necessary, both the object 10 can be moved, and the material remover 140 can be moved, to move the object 10 relative to the material remover 140. Preferably, the movement of each is in opposing direction to the other. Preferably, as to each of the object 10 and the material remover 140, rotation can be in both directions. Further preferably, the object 10 can be selectively locked from rotational movement when the material remover 140 is moved, and the material remover 140 can be selectively locked from rotational movement when the object 10 is moved.

In this regard, movement of the object 10 has been discussed above. It should be moted that whether or not the material remover 140 is moved, movement of the object 10 relative to the material remover 140 removes the material 20.

Similarly, whether or not the object 10 is moved, movement of the material remover 140 relative to the object 10 removes the material 20.

As to movement of the material remover 140, as described above, in the illustrated embodiment, the material remover 140 includes the remover tool 142 having the remover surface 144 biased against the material 20, and the remover tool driver 146 for driving the remover tool 142 to rotate about the longitudinal axis of the remover tool 142 to move the remover surface 144 relative to the material 20.

Further, in the illustrated embodiment, the support structure 110 includes a recess 112 that accommodates the object 10 and permits movement of the material remover 140 relative to the object 10 when the object 10 is accommodated by the recess 112.

More particularly, the recess 112 is open to the alcove 116, such that when the housing 148 is moved into the alcove 116 for engagement with the support structure 110, the remover tool 142 is positioned at least partially within the recess 112 and can rotate about the longitudinal axis of the remover tool 142 at the position.

Further, in the illustrated embodiment, rotation of the material remover 140 about a longitudinal axis of the material remover 140 removes the material 20.

More particularly, in the illustrated embodiment, inasmuch as the label 20 is biased against the remover surface 144 as discussed above, rotation of the remover tool 142 about the longitudinal axis of the remover tool 142 causes the remover surface 144 to move relative to the label 20, which causes the rough texture of the remover surface 114 to remove the label 20 from the body 12, by a removal force, such as for example without limitation, one or more of a tearing force, a shearing force, a cutting force, a pushing force, a scraping force, a scratching force, a rubbing force, or other force.

While in the illustrated embodiment, the remover surface 144 is described as being a rough surface, it should be understood that any one or more aspects of the material remover 140, including without limitation the remover surface 144 and the remover tool 142, can be or include any feature or element that is operatively useful for causing removal of material from objects accommodated by the support structure, without departing from the scope of the invention. For example without limitation, the remover surface can be or include a rough surface, an abrasive surface, a sandpaper-like surface, or a metal scraping surface. Further for example without limitation, the remover tool may have or include a drill bit type of structure (e.g., with a helical structure applied to its length, including flutes and lands), or a sharp metal edge.

Further, in the illustrated embodiment, the bias extends to a distance approximately equal to a thickness of the material 20.

More particularly, in the illustrated embodiment, the label 20 is 1 mm in thickness, and the bias of the label 20 against the remover surface 144 extends approximately 1 mm, such that removal of the label 20 does not cause damage to the body 12 of the bottle 10.

It should be understood that while the distance in the illustrated embodiment is 1 mm, the distance in other embodiments can be larger or smaller than 1 mm, and/or the distance can be of a different magnitude than a thickness of the material, without departing from the scope of the invention. In some embodiments, information may be directly printed on the object, such that removal of the information requires removal of a surface layer of the object itself, that is, removal of the material of the object. In some embodiments, information may be embedded in the object, such that removal of the information requires removal of the material of the object to a depth at which the information is embedded.

It should be understood that in other embodiments, the distance is adjustable. For example without limitation, the engagement of the housing 148 with the support structure 110 can be at multiple positions, each setting a different distance. For example without limitation, one default position can set the distance at 1 mm, a first other position (e.g., 0.5 mm closer to the recess 112 than the default position) can set the distance at 0.5 mm, and a second other position (e.g., 1 mm farther from the recess 112 than the default position) can set the distance at 2 mm.

It should be understood that other ways to make the distance adjustable, such as for example without limitation, by modifying dimensions of, adding to or removing features from, or adding to or removing elements from, any aspect of the apparatus, are contemplated and possible without departing from the scope of the invention.

In the illustrated embodiment, the support structure 110 includes a recess 112 that accommodates the object 10, the recess 112 having a debris collection volume 118 adjacent the object 10 when the object 10 is accommodated by the recess 112.

In the illustrated embodiment, the debris collection volume 118 is below the object 10 when the object is accommodated by the recess 112.

More particularly, in the illustrated embodiment, the recess 112 is deeper than the portion of the bottle 10 that enters the recess 112. In the illustrated embodiment, the portion of the bottle 10 that enters the recess 112 is most of the body 12 of the bottle 10, inasmuch as the feature 114 prevents the entire body 12 from entering the recess 112. The excess depth of the recess 112 serves in the illustrated embodiments as the debris collection volume 118. In the illustrated embodiment, debris from the removal of the label 20, generated at the point of contact between the label 20 and the remover surface 144, is directed by gravity downward from that point of contact and into the debris collection volume 118. When the bottle 10 is removed from the recess 112 after removal of the label 20, the debri in the debris collection volume 118 can accessed and discarded.

It should be understood that while the debris collection volume 118 in the illustrated embodiment is below the recess 112 and the debris is directed to the debris collection volume 118 by gravity, the debris collection volume can be located elsewhere, and the debris from the point of contact can be directed to the illustrated location or such other locations by, for example without limitation, tunnels, vacuum, airflow, movement of components, or other means, without departing from the scope of the invention.

It should further be understood that in other embodiments, the debris collection volume can be partially or fully included in another element or an additional element of the apparatus, including but not limited to an insert that engages with the support structure, housing, or object to capture debris resulting from removal of the material.

In the illustrated embodiment, the apparatus 100 further includes at least one sensor 120 that detects when the material remover 140 is biased against the material 20, the sensor 120 triggering movement of the material remover 140 relative to the object 10.

More particularly, in certain embodiments, the apparatus includes one or more sensors for detecting one or both of the insertion of the object 10 into the recess 112, and the engagement of the housing 148 with the support structure 110. Preferably, the one or more sensors are operative to trigger operation of the remover tool driver 146 to rotate the remover tool 142 to begin removal of the label 20. More particularly, for example without limitation, if the housing 148 is already engaged with the support structure 110, the remover tool driver 146 can be activated upon the object 10 being inserted into the recess 112. Further particularly, for example without limitation, if the object 10 is already inserted into the recess 112, the remover tool driver 146 can be activated upon the housing 148 being engaged with the support structure 110.

In this regard, in the illustrated embodiment, the apparatus 100 includes a sensor 120 that detects, when the object 10 is accommodated by the recess 112, that the housing 148 is engaged with the support structure 110. The sensor 120 is operative to trigger operation of the remover tool driver 146 to rotate the remover tool 142 to begin removal of the label 20.

In preferred embodiments, the support structure 110 may be manufactured or comprised of any material with sufficient strength and durability properties to sustain repeated use of the apparatus 100. For example, without limitation, the housing member 110 may be comprised of one or more of plastic, metal, wood, and composites thereof

It should be understood that discussion of removal or material herein refers to partial or complete removal of material, and it is not limited to partial removal of material, or complete removal of material.

While the present general inventive concept has been illustrated by description of example embodiments, and while the embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant's general inventive concept.

1. An apparatus for removing material from an object, comprising:
a support structure accommodating the object; and
a material remover supported by the support structure and biased against the material; wherein
movement of the object relative to the material remover removes the material.

2. The apparatus of claim 1, wherein the material remover includes a remover surface having a rough texture.

3. The apparatus of claim 1, wherein the bias extends to a distance approximately equal to a thickness of the material.

4. The apparatus of claim 1, wherein the bias extends to a distance and the distance is adjustable.

5. The apparatus of claim 1, wherein rotation of the object about a longitudinal axis of the object removes the material.

6. The apparatus of claim 5, wherein the object is cylindrical and the support structure includes a cylindrical recess that permits rotation of the object, within the recess, about the longitudinal axis of the object.

7. The apparatus of claim 1, wherein rotation of the material remover about a longitudinal axis of the material remover removes the material.

8. The apparatus of claim 1, wherein the support structure includes a recess that accommodates the object and permits movement of the object, within the recess, relative to the material remover.

9. The apparatus of claim 8, wherein a least a portion of the object remains outside the recess when the object is accommodated by the recess.

10. The apparatus of claim 9, wherein the support structure includes a feature that prevents the portion from entering the recess.

11. The apparatus of claim 9, wherein the object includes a feature that prevents the portion from entering the recess.

12. The apparatus of claim 1, wherein the support structure includes a recess that accommodates the object and permits movement of the material remover relative to the object when the object is accommodated by the recess.

13. The apparatus of claim 1, wherein the support structure is configured to bias the object toward the material remover.

14. The apparatus of claim 13, wherein the support structure includes one or more biasing agents that force the object toward the material remover.

15. The apparatus of claim 1, wherein the support structure accommodates a housing for engagement with the support structure, the housing including the material remover, and wherein engagement of the housing with the support structure biases the material remover against the material.

16. The apparatus of claim 1, wherein the material remover includes a remover tool having a remover surface biased against the material, and a remover tool driver for driving the remover tool to rotate about a longitudinal axis of the remover tool to move the remover surface relative to the material.

17. The apparatus of claim 16, wherein the support structure accommodates a housing for engagement with the support structure, the housing including the material remover, and wherein engagement of the housing with the support structure biases the remover surface against the material.

18. The apparatus of claim 1, wherein the support structure includes a recess that accommodates the object, the recess having a debris collection volume adjacent the object when the object is accommodated by the recess.

19. The apparatus of claim 18, wherein the debris collection volume is below the object when the object is accommodated by the recess.

20. The apparatus of claim 1, further comprising at least one sensor that detects when the material remover is biased against the material, the sensor triggering movement of the material remover relative to the object.
